(19) United States
(12) Patent Application Publication
(10) Pub. No.: US 2018/0372432 A1
(43) Pub. Date: Dec. 27, 2018

(54) FLEXIBLE LANCE DRIVE APPARATUS WITH AUTOSTROKE FUNCTION

(71) Applicant: STONEAGE, INC., Durango, CO (US)

(72) Inventor: Travis Watkins, Hesperus, CO (US)

(21) Appl. No.: 16/119,586

(22) Filed: Aug. 31, 2018

Related U.S. Application Data
(62) Division of application No. 15/270,926, filed on Sep. 20, 2016.
(60) Provisional application No. 62/240,169, filed on Oct. 12, 2015.

(51) Int. Cl. F28G 1/04; F28G 15/04; F28G 3/16; B08B 9/043; F28G 15/00

(52) U.S. Cl. CPC F28G 1/04; F28G 15/04; F28G 3/163; F28G 15/003; B08B 9/043

(57) ABSTRACT

An apparatus for sensing an obstruction within a tube being cleaned and repetitively advancing and retracting a flexible high pressure fluid cleaning lance within the tube is disclosed. The method includes sensing a pneumatic supply pressure to a pneumatic lance drive motor at the motor during forward operation, sensing a pneumatic discharge pressure at the drive motor during forward operation, determining a difference between the pressures, comparing the difference to a predetermined difference threshold; reversing the drive motor direction for a predetermined time interval if the difference exceeds the threshold, and restoring forward operation after the predetermined time interval; and repeating the reversing and restoring operations until the difference no longer exceeds the predetermined difference threshold.

### CROSS REFERENCE TO RELATED APPLICATIONS

This application is a divisional of U.S. patent application Ser. No. 15/270,926, filed Sep. 20, 2016, having the Above tile, which claims the benefit of priority of U.S. Provisional Patent Application No. 62/240,169 filed Oct. 12, 2015, the content of which is hereby incorporated by reference in its entirety.

### BACKGROUND OF THE DISCLOSURE

The present disclosure is directed to high pressure fluid rotary nozzle handling systems. In particular, embodiments of the present disclosure are directed to an apparatus for advancing and retracting one or more flexible tube cleaning lances from tubes arranged in an array, such as in a heat exchanger, from a position adjacent a heat exchanger tube sheet, and automatically repetitively reversing forward lance feed movement upon encountering an obstruction within a tube or other piping system being cleaned.

One conventional tube lancing apparatus consists of a rotating reel flexible lance hose take-up and hose dispensing apparatus that carries a predetermined length of flexible lance hose wrapped around a drum. The reel in the drum is rotated by an air motor to push the flexible lance out of the drum and into one or two heat exchanger tubes. The air motor drive can be automatically reversed upon pneumatically sensing a large air pressure increase in air pressure supplied to the forward directional side motor that occurs if the flexible lance being pushed by the reel rotation encounters an obstruction within a tube being cleaned. In this instance, when such a pressure increase is sensed, an air operated valve to the air motor drive shuts off air to the forward side of the air motor and supplies air to the opposite side of the air motor, the air motor reverses, withdrawing the lance for a predetermined time/distance. This automatic reversal of the air motor drive can then be repeated until the obstruction within the tube is removed. In this manner, the flexible lance “pecks” at a restriction, or obstruction, within the tube until the undesirable pressure increase is no longer sensed (indicating that the obstruction has been removed). This drum and reel apparatus necessarily must be somewhat remotely located from the heat exchanger tube sheet in order to accommodate the size of the drum and air drive motor apparatus.

One problem with this approach is that it takes a substantial increase in air pressure—virtually a stall of the flexible lance within the tube, to cause the pressure to increase sufficiently to trigger reversal. Furthermore, if the flexible lance is far within a tube being cleaned, the length of hose within the tube generates resistance against the forward air motor supply pressure pushing the hose into and through the tube, which itself can cause an increase in air supply pressure without there actually being a lance stall. Hence a sufficient pressure change to trigger reversal can occur without the lance actually encountering an obstacle. Further, the forward air pressure applied in a forward direction to the drive motor in typical industrial cleaning operations generally varies widely and thus the conventional system is prone to spurious pneumatic pressure spikes and hence reversals are frequent. This is undesirable. What is needed therefore is an apparatus and method for reliably detecting a restriction within a heat exchanger tube or other piping system conduit being cleaned reliably and with precision.

### SUMMARY OF THE DISCLOSURE

A flexible lance drive apparatus and an automatic blockage sensor in accordance with the present disclosure directly addresses such needs. One exemplary embodiment of a flexible lance drive apparatus in accordance with the present disclosure includes a generally rectangular housing having an array of upper and lower drive rollers in an outer section each rotatably supported by an axle shaft passing laterally through spaced outer and inner walls defining a mid section of the housing. A pneumatic drive motor is housed within the mid section of the housing and is connected to each of the upper and lower drive rollers. Each lower drive roller shaft is rotatably supported in a fixed position and the upper rollers may be lowered against the lower rollers via a pneumatic cylinder to sandwich a flexible lance therebetween. This drive apparatus may be positioned adjacent an entrance into a piping system to be cleaned, such as mounted on a frame fastened to a tube sheet of a heat exchanger tube bundle.

A control console is connected to the drive motor and to the pneumatic cylinder in the drive apparatus via forward and reverse pneumatic pressure supply lines such that an operator can stand at the control console remotely from the drive apparatus so as to avoid the high pressure water spray from the apparatus during operation. The console has forward and reverse manual controls for directing pneumatic pressure via the pneumatic lines to forward and reverse sides of the drive motor. In this embodiment a four way solenoid valve is connected across the forward and reverse pressure lines adjacent the control console. This solenoid valve is operable to reverse the pneumatic pressure connections to the drive motor when energized.

An automatic blockage sensing circuit, in one exemplary embodiment, is mounted within the control console or attached to it, remote from the lance drive apparatus. In other embodiments, the automatic blockage sensing circuit may be housed within the drive apparatus itself. This circuit is operable to sense, at the pneumatic drive motor, a drive motor pressure differential increase above a predetermined threshold and energize the solenoid valve to reverse the pneumatic pressure line connections to the drive motor when this occurs. This function of the automatic blockage sensing circuit and the four way solenoid valve are operable only when the forward manual control at the control console is supplying pneumatic pressure to the drive motor.

The automatic blockage sensing circuit comprises a first pressure transducer connected to a forward air port at the drive motor and a second pressure transducer connected to a reverse air port at the drive motor via sensing lines connected directly to the drive motor, and a microcontroller configured to monitor a differential pressure between the transducers, compare the differential pressure to a predetermined threshold and generate an electrical current output when the threshold is exceeded.

The present disclosure also describes a method of automatically clearing an obstruction encountered while cleaning one or more tubes in a tube sheet of a heat exchanger with a flexible lance drive apparatus having a linear array of driven rollers propelling one or more flexible lances into the one or more tubes. This method includes sensing a pneumatic supply pressure applied to a pneumatic lance drive motor at the pneumatic lance drive motor during forward operation; sensing a pneumatic pressure at an opposite side of the drive motor during forward operation; determining a difference between the pressures; comparing the difference to a predetermined difference threshold; and reversing the supply line connections to the drive motor so as to reverse motor direction for a predetermined time interval if the difference exceeds the threshold The process may include restoring the supply line connections after the predetermined time interval and repeating the sensing, reversing and restoring operations until the difference no longer exceeds the predetermined difference threshold.

Further features, advantages and characteristics of the embodiments of this disclosure will be apparent from reading the following detailed description when taken in conjunction with the drawing figures.

### DESCRIPTION OF THE DRAWINGS

FIG. 1 is a perspective view of a flexible lance drive apparatus in accordance with the present disclosure.

FIG. 2 is a diagram of the pneumatic connections between a remote operator's control console and the drive apparatus shown in FIG. 1.

FIG. 3 is a schematic electrical and pneumatic control diagram of the apparatus shown in FIG. 2.

### DETAILED DESCRIPTION

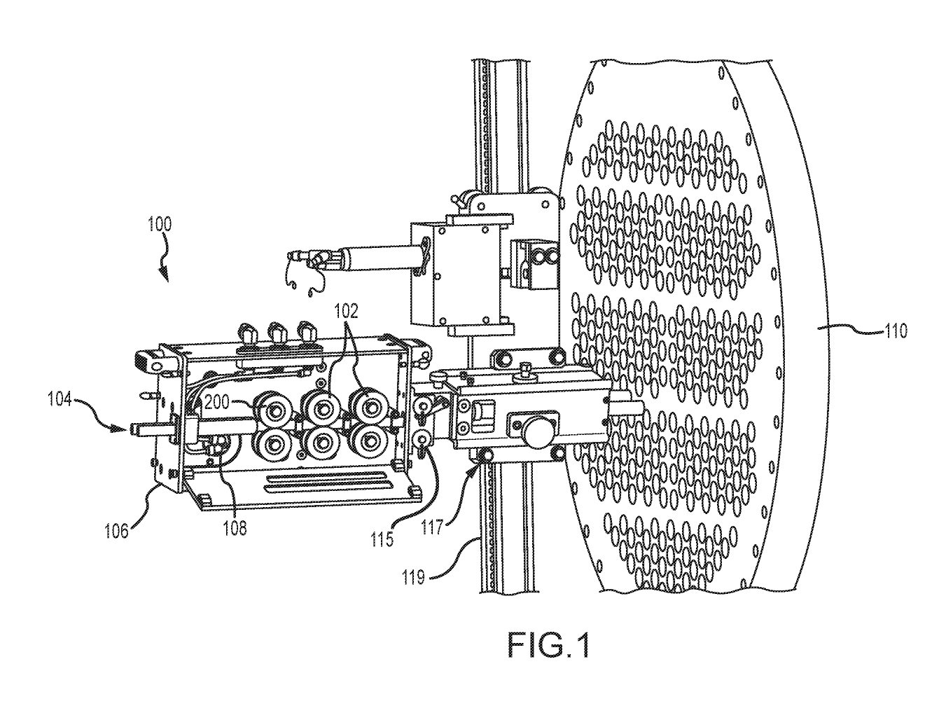

An exemplary drive apparatus 100 incorporating an automatic blockage sensor in accordance with the present disclosure is shown in FIG. 1 with a side cover open showing the set of 3 pairs of drive rollers 102 arranged for driving two flexible lances 104 in accordance with one embodiment of the present disclosure. The apparatus 100 includes a housing 106 in which a drive motor 108 drives each of the six drive rollers 102. FIG. 1 shows a drive apparatus 100 supported for guiding one or more flexible lance hoses 104 into and out of a tube in a tube sheet 110. The drive apparatus 100 is typically mounted on a flexible lance guide 117 which is fastened to a frame 119 that places the drive apparatus 100 in alignment with the tubes penetrating the tube sheet 110.

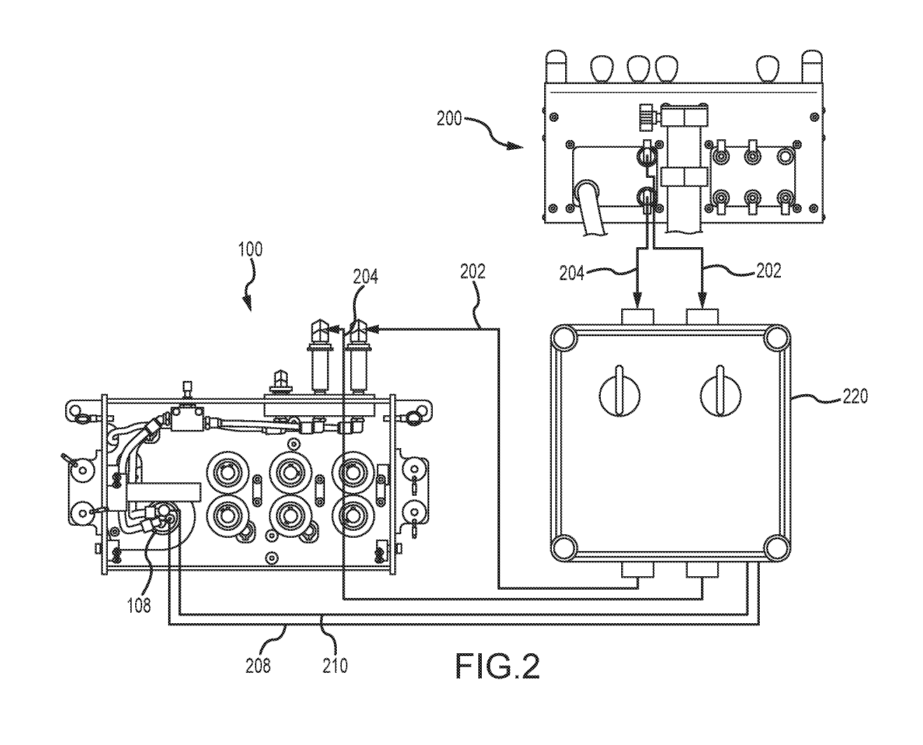

The drive apparatus 100 is pneumatically remotely controlled via a control console 200, as shown in FIG. 2, carried by or positioned adjacent to an operator (not shown) standing a safe distance from the apparatus 100. Attached to the control console 200 is an automatic blockage sensing control circuit box 220. This automatic blockage sensing control circuit box 220 houses an electronic monitoring circuit that monitors air motor pressure at the air motor 108 in the drive apparatus 100 shown in FIG. 1 and controls a solenoid valve also located in or adjacent to the box 220 as will be described more fully below.

The operator preferably can stand about 20-40 feet from the drive apparatus 100. The operator pneumatic control console 200, shown in FIG. 2, in accordance with the present disclosure connects to an air pressure supply source line (not shown) and includes a forward line 202 connected to the air motor 108 in the drive apparatus 100, a retract, or reverse, line 204 connected to the air motor 108, and a clamp air line (not shown) that connects to an air cylinder in the housing 106 in the apparatus 100 for adjusting clamp pressure of the row of upper rollers 102 on the lance(s) 104.

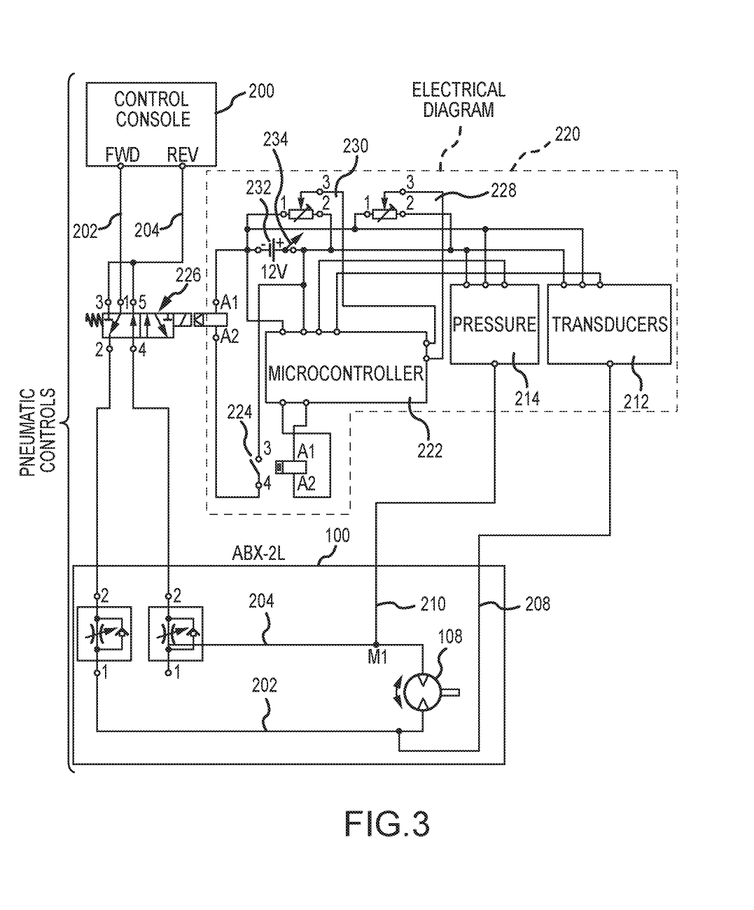

A pair of pressure sensing lines 208 and 210 is connected directly to the forward and reverse ports on the motor 108 in the apparatus 100. These sensing lines 208 and 210 connect to a pair of pressure transducers 212 and 214 mounted in the control box 220 shown in the schematic diagram shown in FIG. 3. Each pressure transducer 212 and 214 produces an electrical signal, either current or voltage, proportional to the pressure sensed at its particular side of the air motor 108.

The automatic blockage sensing control box 220 includes a microcontroller 222 that utilizes the forward pressure signal from transducer 212 to determine when to institute an autostroke cycle or event. More precisely, the microcontroller 222 utilizes the signals from both transducer 212 and 214 to compute a pressure differential. When the pressure differential exceeds a threshold value the autostroke event is triggered. When the pressure difference between the applied air pressure in the forward direction through line 202 sensed at the air motor 108 and the pressure sensed at the reverse port at the air motor 108 increases to a predetermined value indicative of high torque caused by the nozzles encountering a restriction or blockage in the tube(s) being cleaned, the microcontroller 222 produces an output on lines A1-A2 which closes a switch 224 to apply 12 volts DC to a solenoid valve 226 through which the forward and reverse lines 202 and 204 are connected. This switch 224 is preferably a solid state transistor switch. When the solenoid valve 226 is energized, the ports within the valve 226 redirect the forward air motor pressure to the opposite (reverse) side of the air motor 108. After a predetermined period of motor reversal, the solenoid valve 226 is de-energized and the forward air pressure restored to the forward port of the motor 108, at which time forward lance movement resumes if the operator is still pressing the forward control button. If the obstruction is again met, motor pressure again increases as the motor bogs down, and the process repeats.

The automatic blockage sensor control box 220 has two potentiometers 228 and 230. Potentiometer 228 is used to adjust the threshold pressure differential at which the microcontroller 222 will close the switch 224 to energize the solenoid 226, and thereby direct forward drive pneumatic pressure to the reverse port of the air motor 108. The potentiometer 230 is used to adjust the length of time that pneumatic pressure is diverted to the reverse direction of air motor 108, and hence the lance retraction distance before air pressure is restored to the forward direction of the air motor 108.

The microcontroller 222 continually monitors and compares this threshold to the sensed forward pressure via transducer 212. If the pressure difference rises above the threshold, an autostroke event is triggered. When this occurs while the operator is holding the “Hose Feed” control in the forward direction, the microcontroller 222 actuates the solenoid valve 226 which reverses the pneumatic pressure connection from the forward feed line 202 to the reverse line 204. This solenoid valve 226 is a 5-way two position valve that is internally piloted. The forward air hose 202 is connected to the pressure port of the valve 226 and the reverse air hose 204 is tee′d to both of the exhaust ports on the valve which effectively makes valve 226 a 4 way valve. Because the solenoid valve 226 is internally piloted, it will only shift when the operator is driving the drive apparatus 100 forward.

FIG. 3 is a composite schematic of the pneumatic system between the separate control console 200 and the drive apparatus 100, and incorporates, in the dashed portion, the electronic circuitry within the automatic blockage sensor control box 220. The solenoid valve 226 may be mounted within the control box 220 or it may be mounted separately between the control box 220 and the drive apparatus 100. Alternatively the control box 220 and the solenoid valve 226 could be integrated completely into the housing of the drive apparatus 200.

In FIG. 3, the power source 232 is shown as being 12 volts DC. Other supply voltages may be utilized depending on the requirements of the microcontroller 222 and the solenoid valve 226. Furthermore, the power source 232 may be a battery, a series of batteries, or, for example, a pneumatic/electric generator appropriately selected according to the power requirements of the solenoid valve 226 and the microcontroller 222. An on-off switch 234 is also provided in series with the power source 232 to remove the autostroke functionality when not desired.

Many variations are envisioned as within the scope of the present disclosure. For example, all components of the control box 220 may be physically housed within the control console 200. Alternatively, the components within the control box 220 could be integrated into the drive apparatus 100. In alternative embodiments, electrical or hydraulic actuators and motors may be used in place of the pneumatic motors shown and described. Therefore, all such changes, alternatives and equivalents in accordance with the features and benefits described herein, are within the scope of the present disclosure. Such changes and alternatives may be introduced without departing from the spirit and broad scope of this disclosure as defined by the claims below and their equivalents.

What is claimed is:

1. A flexible lance drive apparatus comprising:
a generally rectangular housing having an array of upper and lower drive rollers in an outer section each rotatably supported by an axle shaft passing laterally through spaced outer and inner walls defining a mid section of the housing;
a drive motor within the mid section of the housing connected to each of the upper and lower drive rollers;
wherein each lower drive roller shaft is rotatably supported in a fixed position and the upper rollers may be lowered against the lower rollers via a pneumatic cylinder to sandwich a flexible lance therebetween;
a control console connected to the drive motor via forward and reverse pneumatic pressure supply lines, the console having forward and reverse manual controls for directing pneumatic pressure to forward and reverse ports of the drive motor; and
a solenoid valve connected across the forward and reverse pressure lines operable to reverse pneumatic pressure connections to the drive motor when energized; and
an automatic blockage sensor circuit having pneumatic sensing lines connected directly at the forward and reverse ports on the drive motor, wherein the circuit is operable to sense a drive motor pressure differential between the ports above a predetermined threshold and energize the solenoid valve to reverse the pneumatic pressure supply lines to the drive motor.

2. The apparatus according to claim 1 wherein the solenoid valve is operable only when the forward manual control is supplying pneumatic pressure to the drive motor.

3. The apparatus according to claim 1 wherein the automatic blockage sensor circuit comprises a first pressure transducer connected to a forward side of the drive motor and a second pressure transducer connected to a reverse side of the drive motor and a microcontroller configured to monitor a differential pressure between the transducers to determine the predetermined threshold.

4. A flexible lance hose drive apparatus for propelling at least one high pressure flexible lance hose into and out of at least one heat exchanger tube to be cleaned, the apparatus comprising:
a generally rectangular housing having an array of drive rollers therein;
a pneumatic drive motor within the housing connected to each of the drive rollers;
a control console remote from the housing connected to the drive motor via forward and reverse pneumatic pressure supply lines, the console having forward and reverse manual controls for directing pneumatic pressure to forward and reverse ports of the drive motor; and
a solenoid valve connected across the forward and reverse pressure lines operable to reverse pneumatic pressure connections to the hose drive motor when energized; and
an automatic blockage sensor circuit having pneumatic sensing lines connected directly to the forward and reverse ports on the hose drive motor, wherein the circuit is operable to sense a drive motor pressure differential between the ports above a predetermined threshold and energize the solenoid valve to reverse the connection of pneumatic pressure supply lines to the drive motor to reverse movement of the flexible lance for a predetermined period of time.

5. The apparatus according to claim 4 wherein the automatic blockage sensor circuit performs operations of:
sensing a pneumatic supply pressure to the pneumatic lance drive motor at the drive motor during forward operation;
sensing a pneumatic pressure at an opposite side of the drive motor at the drive motor during forward operation;
determining a difference between the pressures;
comparing the difference to a predetermined difference threshold;
reversing the supply line connections to the drive motor so as to reverse drive motor direction for the predetermined period of time if the difference exceeds the threshold;
restoring the supply line connections after the predetermined period of time; and
repeating the sensing, determining, comparing, reversing and restoring operations until the difference no longer exceeds the predetermined difference threshold.

6. The apparatus according to claim 5 wherein the predetermined time interval is adjustable.

7. The apparatus according to claim 5 wherein the predetermined threshold is adjustable.

8. The apparatus according to claim 4 wherein reversing and restoring is controlled by a microcontroller operated switch.

9. The apparatus according to claim 8 wherein the switch actuates a solenoid valve connecting the pneumatic supply connections to the drive motor.

10. An automatic blockage sensor apparatus for use with a flexible high pressure cleaning lance drive motor comprising:
a first pressure sensor connected to a first directional side of a bidirectional lance drive motor operable to produce a first electrical pressure signal;
a second pressure sensor connected to a second directional side of the bidirectional lance drive motor operable to produce a second electrical signal; and
a control circuit operable to compare the first and second electrical signals, generate an output if the difference between the first and second signals exceeds a predetermined threshold, causing pneumatic pressure to the bidirectional lance drive motor to reverse direction.

11. The apparatus according to claim 10 wherein the first directional side is a forward direction of the lance drive motor.

12. The apparatus according to claim 11 wherein the control circuit includes a microcontroller generating the output and the output closes a switch in a solenoid valve power circuit.

13. The apparatus according to claim 10 further comprising a sensitivity adjustment control for setting the threshold pressure differential.

14. The apparatus according to claim 13 further comprising a reversal duration control connected to the microcontroller for setting a duration for the reverse direction.

15. An automatic blockage sensor apparatus for use with a flexible high pressure cleaning lance drive motor comprising:
a first pressure sensor connected via a sensing line directly to a forward port of a bidirectional lance drive motor operable to produce a first electrical pressure signal;
a second pressure sensor connected via a sensing line directly to a reverse port of the bidirectional lance drive motor operable to produce a second electrical signal; and
a control circuit operable to compare the first and second electrical signals, generate an output if the difference between the first and second signals exceeds a predetermined threshold, and cause the bidirectional lance drive motor to reverse direction.

16. The apparatus according to claim 15 wherein the control circuit includes a switch operated by the output to actuate solenoid valve directing pneumatic supply pressure to the lance drive motor.

17. The apparatus according to claim 15 wherein the control circuit includes a microcontroller for generating the output.

18. A flexible lance drive apparatus comprising:
a pneumatic drive motor operating a plurality of drive rollers to move one or more flexible lances into and out of a conduit to be cleaned;
a control console located remotely from the drive motor, the control console being connected to the drive motor via forward and reverse pneumatic pressure supply lines, the console having forward and reverse manual controls for directing pneumatic pressure to forward and reverse ports of the drive motor;
a solenoid valve connected across the forward and reverse pressure lines operable to reverse pneumatic pressure connections to the drive motor when energized; and
an automatic blockage sensor circuit having pneumatic sensing lines connected directly to forward and reverse ports on the drive motor, wherein the circuit is operable to sense a drive motor pressure differential between the ports above a predetermined threshold and energize the solenoid valve to reverse the pneumatic pressure supply lines to the drive motor.

19. The apparatus according to claim 18 wherein the solenoid valve is energizable only when the forward manual control is supplying pneumatic pressure to the drive motor.

20. The apparatus according to claim 18 wherein the automatic blockage sensor circuit comprises a first pressure transducer connected to a forward port on the drive motor and a second pressure transducer connected to a reverse port on the drive motor and a microcontroller configured to monitor a differential pressure between the transducers to determine the predetermined threshold.
